(19) United States
(12) Patent Application Publication
(10) Pub. No.: US 2008/0166052 A1
(43) Pub. Date: Jul. 10, 2008

(54) FACE CONDITION DETERMINING DEVICE AND IMAGING DEVICE

(76) Inventor: Toshinobu Hatano, Kyoto (JP)

Correspondence Address: MCDERMOTT WILL & EMERY LLP, 600 13TH STREET, NW, WASHINGTON, DC, 20005-3096, US

(21) Appl. No.: 11/970,122

(22) Filed: Jan. 7, 2008

(30) Foreign Application Priority Data
Jan. 10, 2007 (JP) 2007-002230
Jan. 10, 2007 (JP) 2007-002231

(51) Int. Cl. G06K 9/00; G06K 9/36; G06K 9/46; G06K 9/68

(52) U.S. Cl. 382/190; 382/103; 382/218; 382/312; 382/236

(57) ABSTRACT

A face area detector detects a face area of a photographic subject in image data. A particular section detector detects a particular section in the face area. A motion detector extracts a difference between the image data of the particular section in a current frame of the image data and the image data of the particular section in the previous frame of the image data. A face condition determiner determines a face condition of the photographic subject based on the motion information of the particular section.

### BACKGROUND OF THE INVENTION

1. Field of the Invention

The present invention relates to a face condition determining device and an imaging device for monitoring and imaging a vehicle driver using an in-vehicle camera and determining if the driver is, for example, drowsy while driving as a part of a fail-safe image processing technology for preventing the occurrence of an accident.

2. Description of the Related Art

In recent years, a camera technology for monitoring a vehicle driver in order to prevent the occurrence of an accident has been increasingly materialized, to which improvement in the speed and image quality of a digital camera has been contributing.

An example of an image processing device for detecting eye conditions of the driver and the like is recited in No. H04-174309 of the Japanese Patent Applications Laid-Open, a basic structure of which is shown in FIG. 8. Referring to reference numerals shown in FIG. 8, 31 denotes an infrared stroboscope for irradiating a driver's face, 32 denotes a TV camera for imaging the driver's face, 33 denotes a timing instructing circuit for coordinating timings of the light emission of the infrared stroboscope 31 and the image input of the TV camera 32, 34 denotes an A/D converter for converting the inputted image obtained by the TV camera 32 into a digital amount, 35 denotes an image memory in which the image data is stored, 36 denotes an eyeball position defining circuit for defining the position area of the eyeballs in the image data read from the image memory 35, 37 denotes an iris detecting circuit for detecting an iris part of the eyeball by processing the image data in the image memory 35 in the area defined by the eyeball position defining circuit 36, and 38 denotes a drowsy/inattentive driving determining circuit for determining the driver's conditions including whether he/she is drowsy or inattentively driving from a result of the detection on the iris part.

In the device, the image data of the driver's face is converted into binary data in the A/D converter 34. The eyeball position defining circuit 36 detects the continuity of white pixels or black pixels in the binarized image data in horizontal and vertical directions to thereby detect the eyeball position and face width of the driver. The iris detecting circuit 37 detects the iris part of the eyeball. The drowsy/inattentive driving determining circuit 38 determines if the driver has his/her eyes open or closed based on the iris detection result, and further determines if the driver is, for example, drowsy or inattentively driving based on a result of the determination. This technology is utilized to give a warning when the driver is drowsy while driving or inattentively driving.

The conventional image processing device thus described is effective only when the face is looking forward while being imaged. When the vehicle is actually driven, however, the position and angle of the driver's face changes because he/she, in one position for too long, feels weary or drowsy. As a result, accuracy in detecting the face width and the eye position is deteriorated.

### SUMMARY OF THE INVENTION

Therefore, a main object of the present invention is to improve an accuracy when a face area and eye blinks are detected.

A face condition determining device according to the present invention comprises:

a brightness signal extractor for extracting a brightness signal of image data comprising continuous frame images;

a resizing processor for resizing the brightness signal into a size demanded when a face area of a photographic subject in the brightness signal is detected;

a memory in which the resized brightness signal for at least one frame is stored;

a face area detector for reading the resized brightness signal from the memory and detecting the face area of the photographic subject in the brightness signal;

a particular section detector for detecting a particular section in the face area;

a motion detector for extracting a difference between the image data of the particular section in a current frame of the image data and the image data of the particular section in the previous frame of the image data read from the memory as motion information of the particular section; and

a face condition determiner for determining a face condition of the photographic subject based on the motion information of the particular section.

In the constitution, the face area and the particular section (an eye section or a mouth section) are detected at the same time for each frame, and the face condition is determined by the face condition determiner based on the motion information of the particular section. As a result, the condition of the particular section can be accurately determined. Thus, the face determining device has an advantage in that it is determined in a stable manner that the driver is drowsy.

A face condition determining device according to the present invention comprises:

a memory in which image data is stored;

a resizing processor for resizing the image data read from the memory into a size demanded when a face area of a photographic subject in the image data is detected and storing the resized image data again in the memory;

a face area detector for detecting the face area of the photographic subject in the resized image data read from the memory;

a motion vector detector for detecting a motion vector for each basic block in the image data read from the memory or the resized image data;

a particular section motion information calculator for estimating a particular section in the face area and calculating a variation of the motion vector for each frame in the estimated particular section based on the motion vector for each basic block detected by the motion vector detector; and

a face condition determiner for determining a face condition of the photographic subject based on the variation of the motion vector for each frame of the particular section.

In the constitution, the motion vectors of the face area and the particular section (an eye section or a mouth section) are detected at the same time by each frame so that the face condition is determined by the face condition determiner based on the motion vector of the particular section. As a result, the condition of the particular section can be accurately determined. Thus, the face determining device has an advantage in that it is stably determined that the driver is drowsy.

In the face condition determining device thus constituted, the resizing processor preferably trims or partially enlarges the face area of the image data to thereby generate the image data for which the motion vector is extracted by the motion vector detector. Accordingly, when the motion vector detector extracts the motion vector for each basic block, the size of the face area can be large enough in comparison to a size adopted in the processing of the basic block.

According to the present invention, the vehicle driver is continuously monitored and imaged with the in-vehicle camera so that the motion information or the motion vector of the face area and the particular section (eyes or a mouth) are detected at the same time, and the fact is thereby stably detected that the driver is, for example, drowsy while driving through the judgments on the motion of the eyes or mouth. According to the present invention, a monitor camera system for the vehicle driver, which can be used as a fail-safe technology for preventing the occurrence of an accident, can be provided.

According to the face condition determining device of the present invention, the variation of the motion of the eyes or mouth is estimated concurrently with the detection of the face area while the vehicle driver is continuously monitored and imaged with the in-vehicle camera so that the fact is stably detected that the driver is drowsy, for example. The face condition determining device is useful as a monitor camera system for the vehicle driver which can be used as a fail-safe technology for preventing the occurrence of an accident.

### BRIEF DESCRIPTION OF THE DRAWINGS

These and other objects of the invention will become clear by the following description of preferred embodiments of the invention and be specified in the claims attached hereto. A number of benefits not recited in this specification will come to the attention of the skilled in the art upon the implementation of the present invention.

FIG. 1 is a block diagram illustrating a constitution of an image processing device including a face condition determining device according to a preferred embodiment 1 of the present invention.

FIG. 2 is a block diagram illustrating a detailed internal structure of the face condition determining device according to the preferred embodiment 1.

FIGS. 3A-3B are conceptual views of divided face areas in an image of a photographic subject as a vehicle driver according to the present invention.

FIG. 4 is a waveform chart illustrating the operation of the face condition determining device according to the preferred embodiment 1.

FIG. 5 is a block diagram illustrating a constitution of a face condition determining device according to a preferred embodiment 2 of the present invention.

FIG. 6 is a block diagram illustrating a constitution of an imaging device according to the preferred embodiment 2.

FIGS. 7A-7B are conceptual views of divided face areas in an image of a photographic subject as a vehicle driver according to the present invention.

FIG. 8 is a block diagram illustrating a constitution of a face condition determining device according to a conventional technology.

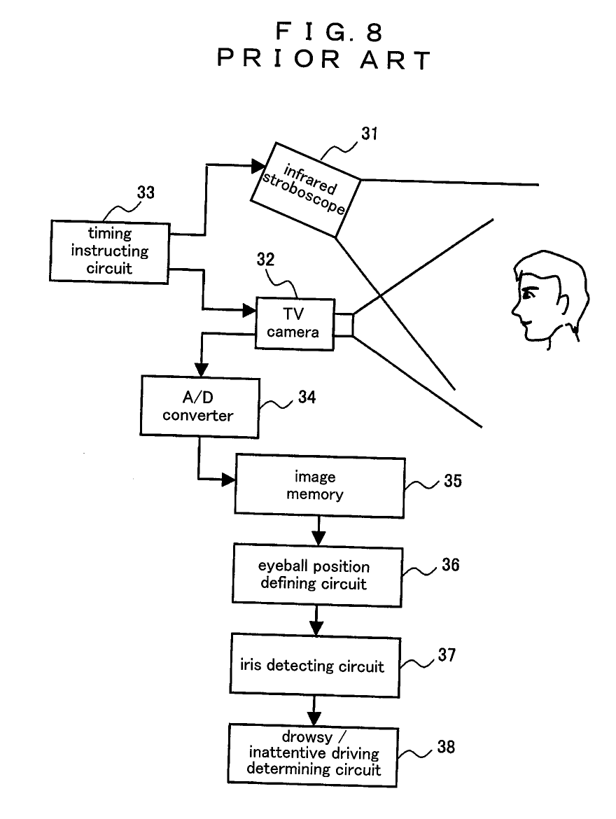

### DETAILED DESCRIPTION OF THE INVENTION

Hereinafter, preferred embodiments of a face condition determining device according to the present invention are described in detail referring to the drawings.

### Preferred Embodiment 1

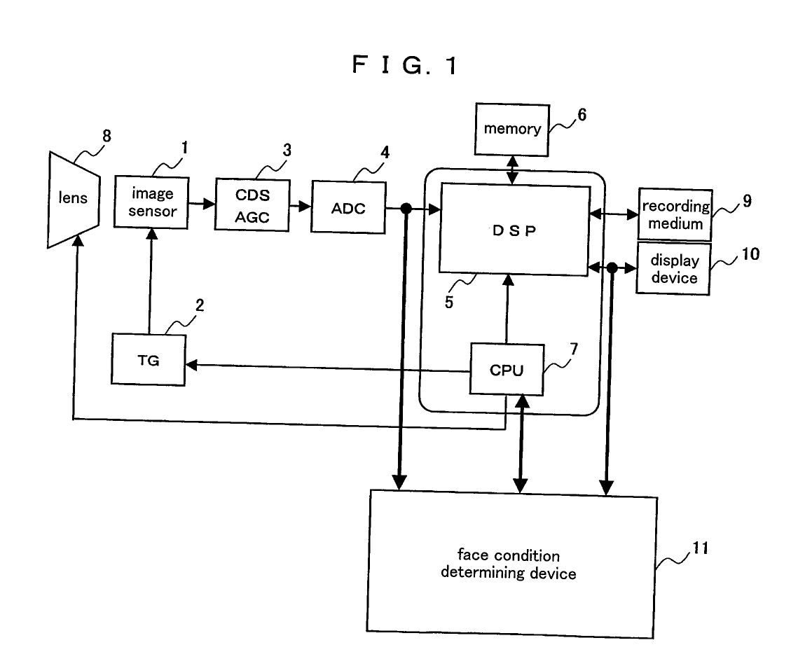

FIG. 1 is a block diagram illustrating a constitution of an image processing device (camera system) including a face condition determining device according to a preferred embodiment 1 of the present invention. Referring to reference numerals shown in FIG. 1, 1 denotes a two-dimensional image sensor, 2 denotes a timing generator (TG) for generating a drive pulse of the two-dimensional image sensor 1, 3 denotes a CDS/AGC circuit for removing noise of an imaging video signal outputted from the two-dimensional image sensor 1 and controlling a gain thereof, 4 denotes an AD converter (ADC) for converting an analog video signal into digital image data, 5 denotes a DSP (digital signal processing circuit) for executing various types of processing by executing a predetermined program, 6 denotes a memory in which image data and other various types of data are stored, 7 denotes a CPU (microcomputer) for controlling an operation of the entire camera system through a control program, 8 denotes a lens unit including an imaging lens, 9 denotes a recording medium, 10 denotes a display device, and 11 denotes a face condition determining device according to the present preferred embodiment. The face condition determining device 11 is connected to the CPU 7 in such a manner that an output of the AD converter 4 and an image to be displayed outputted from the DSP 5 are inputted thereto.

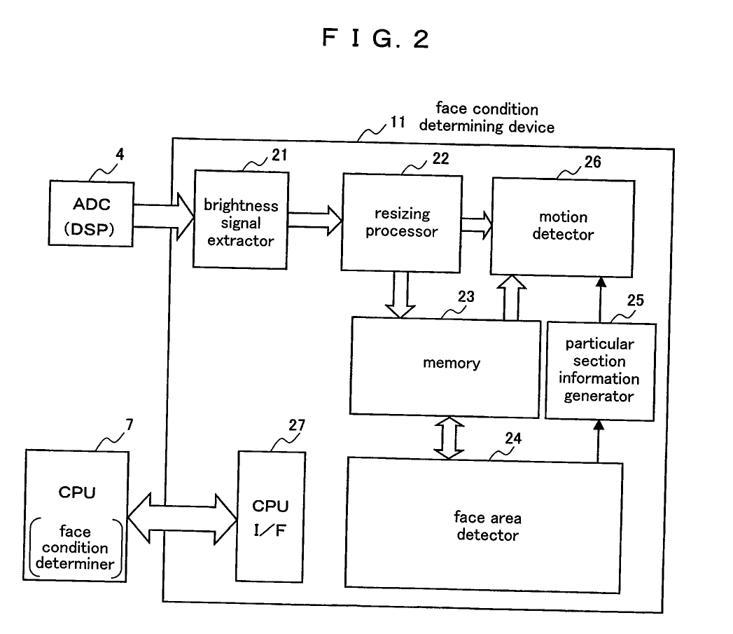

FIG. 2 is a block diagram illustrating a detailed internal structure of the face condition determining device 11. Referring to reference numerals shown in FIG. 2, 21 denotes a brightness signal extractor, 22 denotes a resizing processor, 23 denotes a memory in which the image data is stored, 24 denotes a face area detector, 25 denotes a particular section information generator, 26 denotes a motion detector, and 27 denotes a CPU interface.

The brightness signal extractor 21 extracts a brightness signal from the image data AD-converted by the AD converter 4, REC601 (STD signal generated by the processing of the DSP5), REC656 data, or input format image data of the display device 10. As pre-processing to be executed before image data is inputted to the face condition determining device 11, the brightness signal extractor 21 extracts the brightness signal from the image signal.

The resizing processor 22 filters and downsizes the brightness signal extracted by the brightness signal extractor 21. The memory 23 stores the resized image data (brightness signal) for at least one frame. The face area detector 24 accesses the resized image data stored in the memory 23 and detects the face area and the size and tilt of the face to thereby generate face area information. The particular section generator 25 generates information of the particular section of the face such as the eyes, nose, cheek or mouth as a frame signal based on the face area information of the face area detector 24. The motion detector 26, as update processing of moving-image frames, extracts a difference between the particular section information of a current frame obtained by the particular section information generator 25 in current frame data outputted from the resizing processor 22 and the particular section information of the previous frame read from the memory 23 as a motion information. The CPU interface 27 is connected to the CPU 7 and controls the system operation of the respective processing units through a control program. The CPU 7 comprises, as a part of its function, a face condition determiner for determining a face condition based on the face area information by the face area detector 24 and the particular section motion information by the motion detector 26.

Next, the operation of the image processing device including the face condition determining device thus constituted is described. First, a typical recording/reproducing operation executed when a moving image is obtained is described. When an imaging light enters the two-dimensional image sensor 1 via the lens in the lens unit 8, an image of the photographic subject is converted into an electrical signal by a photo diode or the like, and an imaging video signal, which is an analog continuous signal, is generated in the two-dimensional image sensor 1 in accordance with horizontal and vertical drives synchronizing with a drive pulse from the timing generator 2, and then, outputted. The 1/f noise of the imaging video signal outputted from the two-dimensional image sensor 1 is appropriately reduced by the sample hold circuit (CDS) of the CDS/AGC circuit 3, and the noise-reduced video signal is automatically gain-controlled by the AGC circuit of the CDS/AGC circuit 3. The imaging video signal thus processed is supplied to the AD converter 4 from the CDS/AGC circuit 3. The AD converter 4 converts the supplied imaging video signal into image data (RGB data). The obtained image data is supplied to the DSP 5. The DSP 5 executes various types of processing (bright-signal processing, color-separation processing, color-matrix processing, data compression, resizing and the like). The DSP 5 resizes the processed image data into a display size, and then, outputs the resized image data to the display device 10. The image data is transmitted to and recorded in the recording medium 9 in the case where the recording operation is selected. When the foregoing series of operation thus described with respect to the image of an arbitrary one frame is repeatedly executed in parallel as continuous moving-image frame processing, the moving image is outputted.

Next, the operation of the face condition determining device 11 is described in detail. The brightness signal extractor 21 generates brightness-signal data in accordance with the image data. The brightness-signal data is used when the face area and the motion are detected. The brightness signal extractor 21 may generate the brightness-signal data based on the brightness-signal data of REC601 (STD signal generated by the processing of the DSP 5), REC656 data or the image data in compliance with an input format of the display device 10 in place of the image data.

The brightness-signal data outputted from the brightness signal extractor 21 is supplied to the resizing processor 22, where the image is resized. Next, the resizing processing is described. The brightness-signal data outputted from the brightness signal extractor 21 does not define the size of the image. In the face area detection implemented by the face area detector 24 and the motion detection implemented by the motion detector 26, on the contrary, the size of the image to be processed in the respective processes is defined. Therefore, the resizing processor 22 resizes the brightness-signal data inputted with an arbitrary image size into the image size defined in the face area detection and the motion detection. The resizing processor 22 filters and downsizes the brightness-signal data to thereby adjust the image size. The resizing processor 22 stores the resized brightness-signal data (hereinafter, referred to as resized image data) in the memory 23.

The face area detector 24 reads the resized image data stored in the memory 23, and detects the face area in the resized image data and extracts the size and tilt of the face. The CPU 17 confirms via the CPU interface 27 that face area detection information is detected by the face information detector 24, and instructs the particular section information generator 25 to generate the particular section information. The particular section information generator 25 generates the particular section information based on the instruction from the CPU 7. More specifically, the particular section information generator 25 identifies a particular section of the face (an eye section, a nose/cheek section, a mouth section or the like) based on the face area detection information detected by the face area detector 24 and generates the particular section information (frame information or the like) indicating the particular section, and then, supplies the generated information to the motion detector 26. The motion detector 26 detects each particular section in the resized image data of the current frame supplied from the resizing processor 22 and each particular section in the previous frame read from the memory 23 based on the particular section information. Further, the motion detector 26 extracts the difference between the image data in each particular section of the current frame and the image data in each particular section of the previous frame read from the memory 23 as the motion information of each particular section. The motion information of each particular section is extracted when the moving image frame is updated. The motion detector 26 supplies the extracted motion information to the CPU 7 via the CPU interface 27.

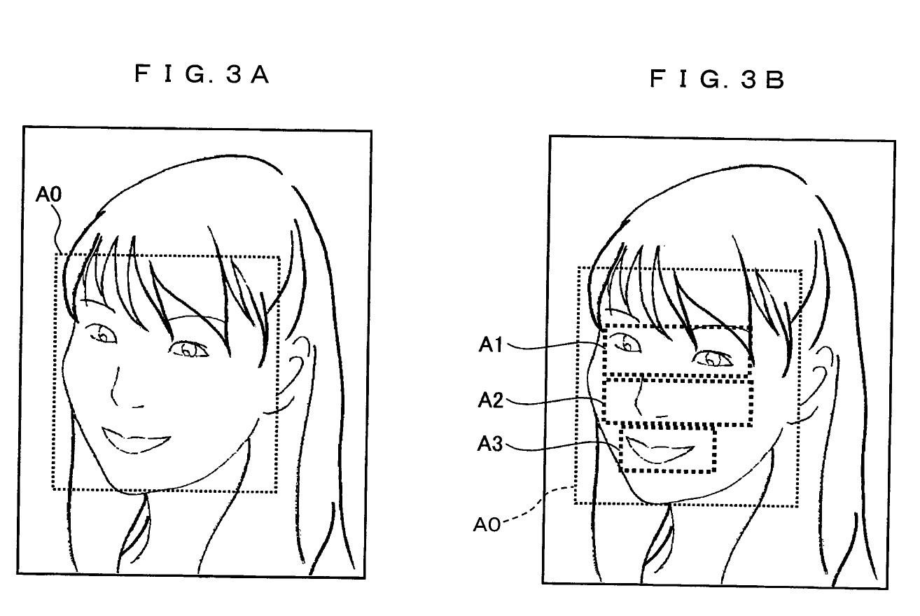

The operations of the respective processing units are executed based on a sequence operation by each frame through a control program executed by the CPU 7. It is assumed that the image data shown in FIG. 3A, for example, is obtained by the sequence operation, and information relating to a face area A0 (hereinafter, referred to as face area information) in the image data is obtained by the face area detection executed by the face area detector 24. As shown in FIG. 3B, the particular section information generator 25 generates information relating to an eye section A1 including both eyes (hereinafter, referred to as eye section information), information relating to a nose/cheek section A2 including nose and cheek (hereinafter, referred to as nose/cheek section information), and information relating to a mouth section A3 (hereinafter, referred to as mouth section information) based on the face area information. These pieces of information include information showing frames of the sections A1-A3. The motion detector 26 compares the images in the current and previous frames with respect to the eye section information, nose/cheek section information and mouth section information to thereby extract the motion information. The motion information is extracted as a difference of data on a time axis concerning both the images. The CPU 7 (more specifically, face condition determiner) reads the motion information extracted by the motion detector 26 and compares an absolute value of the motion information at the nose/cheek section A2 to a predetermined threshold value. The face condition determiner renders the following judgment on the face condition based on a result of the comparison. When the absolute value of the motion information at the nose/cheek section A2 is at most the threshold value, the face condition determiner determines that the face area A0 in the frame is at a fixed position. Alternatively, the face condition determiner may determine whether or not a variation amount of the entire face area A0 is at most a predetermined threshold value (this threshold value is a value specific to the variation amount) and determine that the face area A0 is at a fixed position when the variation amount of the entire face area A0 is at most the predetermined threshold value.

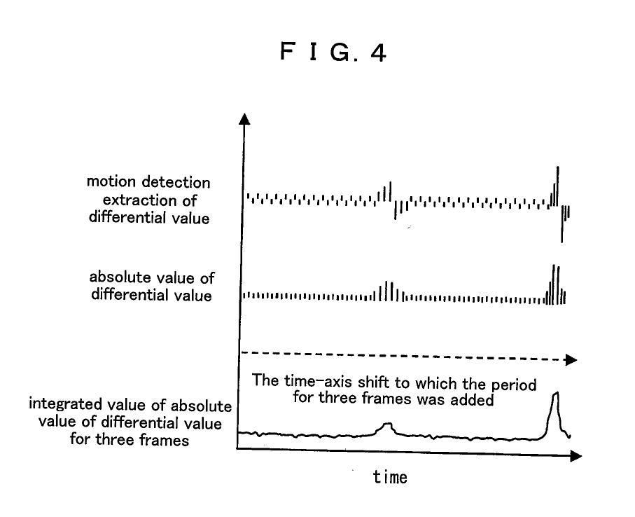

When it is thus determined that the face area A0 is at a fixed position, the face condition determiner determines whether or not the motion information in the eye section A1 is at least a predetermined threshold value (this threshold value is also a value specific to this variation amount) as shown in FIG. 4. When it is determined that the motion information in the eye section A1 is at least the predetermined threshold value as a result of the determination, the face condition determiner determines that the eyes are being blinked.

Further, the face condition determiner focuses on the motion information in the eye section A1 when the eyes blinks are detected. The face condition determiner compares the motion information in the eye section A1 to a predetermined threshold value (this threshold value is a value specific to this motion information), and regards the number of times (the number of pulses) the motion information becomes at least the predetermined threshold value as the number of blinks as a result of the comparison. Based on the foregoing findings, the face condition determiner counts the number of pulses to thereby detect the number of blinks per unit time.

Further, the face condition determiner focuses on an absolute value of the motion information in the eye section A1 when the eyes blinks are detected. The face condition determiner memorizes the past record of an integrated value per unit time of the absolute value of the motion information. Then, the face condition determiner compares the integrated value currently calculated to the record. When it is confirmed that the current integrated value is less in comparison to the record, the face condition determiner determines that the number of blinks is decreasing.

Further, the face condition determiner focuses on an absolute value of the integrated value. The face condition determiner calculates a variation amount of the absolute value per frame or every several frames. Then, the face condition determiner determines that the speed at which eyes are blinked is decreasing when the calculated variation amount decreases over time.

Further, the face condition determiner focuses on the motion information in the mouth section A3 at the time when the eyes blinks are detected. The face condition determiner compares the motion information in the mouth section A3 to a predetermined threshold value (this threshold value is a value specific to this variation amount). When it is determined from a result of the comparison that the motion information in the mouth section A3 is at most the predetermined threshold value, the face condition determiner determines that the photographic subject is engaged in conversation because the motion information in the mouth section A3 randomly changes in the state where the face area A1 is substantially fixed in the frame.

Further, the face condition determiner determines whether or not the motion information in the mouth section A3 randomly changes when it is determined that the photographic subject is engaged in conversation. Further, the face condition determiner compares the integrated value per unit time of the absolute value of the motion information (absolute value of differential value) in the mouth section A3 to its record when it is determined that the motion information in the mouth section A3 randomly changes. When it is determined that the integrated value is less in comparison to the record, the face condition determiner determines that the photographic subject gradually talks less.

The face condition determiner determines whether or not the photographic subject is in a drowsy state based on one or the combination of two judgments: the judgement that the number of blinks becomes less and, at the same time, the speed at which the eyes are blinked is decreasing and the judgment that he/she gradually talks less. More specifically, the face condition determiner determines that the photographic subject is in a drowsy state when it is determined that the number of blinks becomes less and, at the same time, the speed at which the eyes are blinked is decreasing.

As described, according to the present preferred embodiment constituted in such a manner that the face area and the motion of the particular section (eyes or a mouth) in the face area can be detected with respect to an arbitrary image at the same time, the condition of the particular section can be accurately determined. As a result, the fact can be accurately detected that the driver is, for example, drowsy while driving. Further, even in the case when a vehicle is actually driven and the driver's face is tilted because he/she, in one position for too long, feels weary or drowsy, the face area, the eye blinks and the motion of the mouth can be accurately detected.

### Preferred Embodiment 2

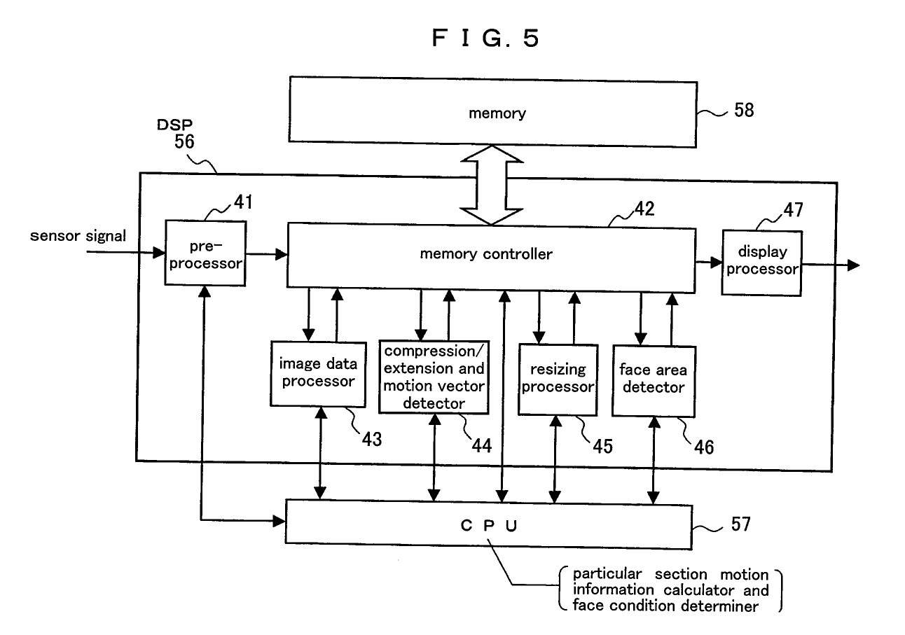

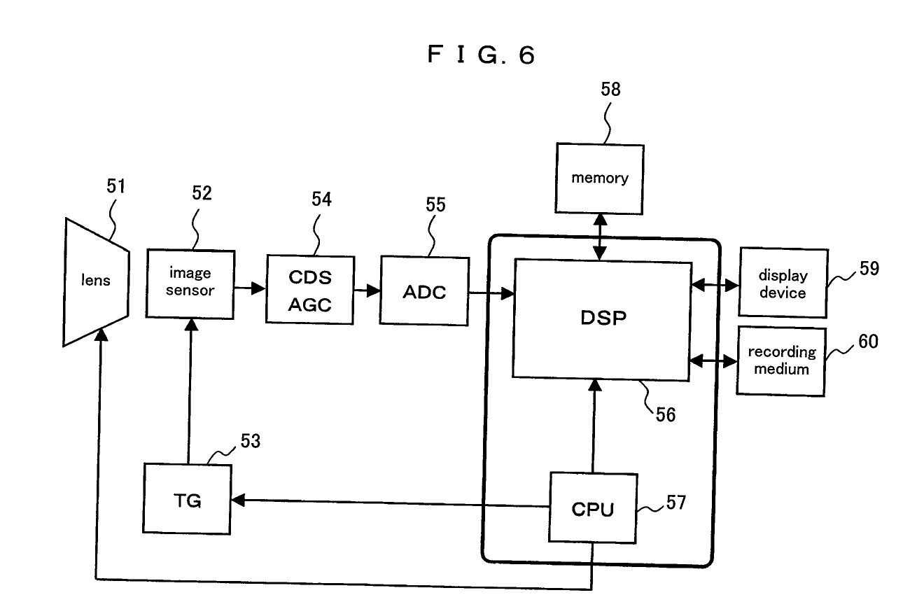

A face condition determining device according to a preferred embodiment 2 of the present invention is described in detail referring to the drawings. FIG. 5 is a block diagram illustrating a constitution of the face condition determining device according to the present preferred embodiment. FIG. 6 is a block diagram illustrating a constitution of an imaging device according to the present preferred embodiment. First, the imaging device is described referring to FIG. 6. Referring to reference numerals shown in FIG. 6, 51 denotes a lens unit including an imaging lens, 52 denotes a two-dimensional image sensor, 53 denotes a timing generator (TG) for generating a drive pulse of the image sensor 52, 54 denotes a CDS/AGC circuit for removing noise of an imaging video signal outputted from the image sensor 52 and controlling a gain thereof, 55 denotes an AD converter (ADC) for converting an analog video signal into digital image data, 56 denotes a DSP (digital signal processing circuit) for executing various types of processing (including the face area detection and the motion detection) through a predetermined program being executed, 57 denotes a CPU (microcomputer) for controlling the whole system operation of the imaging device through the control program, 58 denotes a memory in which image data and various data are stored, 59 denotes a display device, and 60 denotes a recording medium. The face condition determining device according to the present preferred embodiment comprises the DSP 56 and the CPU 57.

The description of the operation of the imaging device according to the present preferred embodiment thus constituted, which is basically similar to that of the preferred embodiment 1, is omitted.

Referring to reference numerals in FIG. 5 which shows the details of the DSP 56, 41 denotes a pre-processor for executing pre-processing such as black level adjustment and gain adjustment to image data fetched into the DSP 56 from the A/D converter 55, 42 denotes a memory controller for controlling the write and read of the image data between the respective components and the memory 58, 43 denotes an image data processor for executing a brightness-signal processing and a color-signal processing to the image data read from the memory 58 via the memory controller 42 and writing the resulting image data back into the memory 58 as brightness data and color-difference data (or RGB data), and 44 denotes a compression/extension and motion vector detector for compressing and extending the moving images of the brightness data and the color-difference data and outputting a motion vector information for each basic block. The detection of the motion vector is implemented as an internal function of the moving-image compression. 45 denotes a resizing processor for resizing and gain-adjusting the original image data read from the memory 58 via the memory controller 42 (brightness data and color-difference data (or RGB data)) in horizontal and vertical directions and writing the resulting resized image data back into the memory 58. 46 denotes a face area detector for detecting a face area from the image data read from the memory 58. 47 denotes a display processor for transferring the image data to be displayed received from the memory controller 42 to the display device 59. The CPU 57 comprises a particular section motion information calculator and a face condition determiner. The particular section motion information calculator extracts a variation of the motion vector per frame in the particular section of the face area shown by the face area information by the face area detector 46 from the motion vector information for each basic block by the compression/extension and motion vector detector 44 and outputs the extracted variation as the particular section motion information. The face condition determiner determines a face condition based on the face area information by the face area detector 46 and the particular section motion information by the particular section motion information calculator.

Next, the operation of the face condition determining device according to the present preferred embodiment thus constituted is described. The image data fetched into the DSP 56 is subjected to the pre-processing such as the black-level adjustment and the gain adjustment by the pre-processor 41, and written in the memory 58 via the memory controller 42. The image data processor 43 reads the image data written in the memory 58 via the memory controller 42 and executes the brightness-signal processing and the color-signal processing thereto, and writes the resulting image data back into the memory 58 via the memory controller 42 as the brightness data and color-difference data (or RGB data).

The resizing processor 45 reads the original image data from the memory 58 via the memory controller 42 and horizontally and vertically resizes the read image data, and writes the resized image data back into the memory 58.

The face area detector 46 reads the resized image data for detecting the face area from the memory 58 via the memory controller 42, and detects the information such as the face area, and the size and tilt of the face. Further, in parallel with the detection, the compression/extension and motion vector detector 44 periodically reads the resized image data or the full image data before the resizing process from the memory 48 via the memory controller 42, and compresses the inputted moving-image frame data and writes the compressed image data back into the memory 18 so that the compressed image data is stored in a memory space. At the time, the compression/extension and motion vector detector 44 detects the motion vector as intermediate processing in the moving-image compression, and also outputs the motion vector for each basic block obtained as a result of the detection of the motion vector. The obtained motion vectors is be stored either in the memory 58 via the memory controller 42 or in an internal register of the compression/extension and motion vector detector 44. The respective components execute the before-mentioned operations based on the sequence operation of each frame. The sequence operation is executed based on the control program executed by the CPU 57.

The resizing processor 45 generates the image data to be displayed by horizontally and vertically resizing the relevant image data into a size optimum for the display in the entire surface thereof, and outputs the generated image data to be displayed to the display processor 47.

In the foregoing process, the face condition is determined by the CPU 57 as follows. The CPU 57 executes the predetermined control program to thereby:
extract the variation of the motion vector per frame in the particular section such as eyes, a nose, mouth or cheek of the face from the motion vector information for each basic block by the compression/extension and motion vector detector 44 and generate the particular section motion information; and
determine if the driver is in a drowsy state or the like based on the face area information by the face area detector 46 and the particular section motion information by the particular section motion information calculator.

These types of processing are executed by the particular section motion information calculator and the face condition determiner of the CPU 57. Below are given details.

The information such as the face area and the size and tile of the face obtained by the face area detector 46 and the information such as a resizing factor in the resizing processor 45 are inputted to the CPU 57. The CPU 17 estimates the particular section such as eyes, a nose, mouth or cheek in the face image of the original image based on these pieces of information. In relation to any of the estimated particular sections, the compression/extension and motion vector detector 4 has already written the motion vector information for each basic block in the memory 58 or the register of the compression/extension and motion vector detector 44. Then, the CPU 57 reads the motion vector information for each basic block of the estimated particular section from the memory 58 or the compression/extension and motion vector detector 44. The CPU 57 extracts the variation of the motion vector per frame of the particular section based on the foregoing information to thereby generate the particular section motion information. The function of generating the particular section motion information by the CPU 57 serves as the particular section motion information calculator.

The CPU 57 determines the face condition such as the driver being in a the drowsy state or the like based on the particular section motion information extracted by itself (particular section motion information calculator) and the face area information extracted by the face area detector 46. The function of determining the face condition by the CPU 17 serves as the face condition determiner.

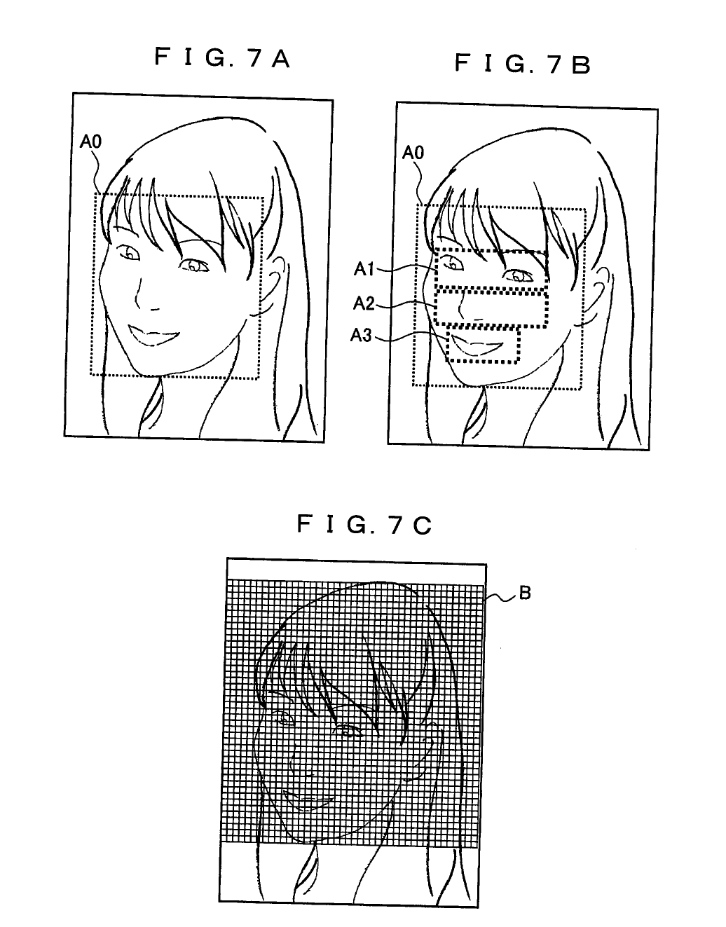

It is assumed that such an image data as shown in FIG. 7A is obtained by the sequence operation, and the information relating to the face area A0 (hereinafter, referred to as face area information) in the image data is obtained in the face area detection by the face area detector 46. Further, as shown in FIG. 7B, the information relating to the eye section A1 including both eyes (hereinafter, referred to as eye section information), the information relating to the nose/cheek section A2 including the nose and cheek (hereinafter, referred to as nose/cheek section information) and the information relating to the mouth section A3 (hereinafter, referred to as mouth section information) are generated based on the face area information estimated and calculated by the CPU 57. The resizing factor of the resizing processor 45 is used in the estimation/calculation. The compression/extension and motion vector detector 44 extracts the motion vector information of the image parts of the eye section A1, nose/cheek section A2 and mouth section A3. The motion vector information is extracted for each basic block shown by B in the original image in FIG. 7C. Further, the CPU 57 (particular section motion information calculator) extracts the variation of the motion vector per frame in the particular section from the extracted motion vector information to thereby generate the particular section motion information. The CPU 57 (face condition determiner) determines whether or not the face area A0 in the frame is at a fixed position based on the face area information and the particular section motion information. The determination is done depending on whether or not the variation amount of the face area information A0 is at most a predetermined threshold value (this threshold value is a value specific to this variation amount). Further, the CPU 57 (face condition determiner) determines if the value of the motion information on the time axis in the eye section A1 is at least a predetermined threshold value (this threshold value is a value specific to this motion information) in a manner similar to the description referring to FIG. 4 in the preferred embodiment 1 when it is determined that the face area is at a fixed position. In the determination, the CPU 57 determines that the eyes are blinked when the value of the motion information is at least the predetermined threshold value.

At the time, the CPU 57 (face condition determiner) counts the number of pulses at the time when the value of the motion information on the time axis in the eye section A1 is at least the predetermined threshold value to thereby extract the information showing how many times the eyes are blinked per unit time.

Further, the CPU 57 (face condition determiner) determines whether or not the integrated value per unit time of the absolute value of the motion information on the time axis in the eye section A1 at the time is reduced in comparison to the integrated value in the past record. The CPU 57 determines that the number of blinks is decreasing when the reduction is detected as a result of the determination.

Further, the CPU 57 (face condition determiner) determines whether or not the variation amount per frame of the integrated value per unit time at the time is reduced. The CPU 57 determines that the speed at which the eyes are blinked is decreasing when a result of the determination shows that the variation amount per frame is reduced.

The CPU 57 (face condition determiner) determines whether or not the value of the motion information on the time axis in the mouth section A3 at the time is at most a predetermined threshold value. The CPU 57 determines that the face area in the frame is at a fixed position when the value of the motion information is at most the predetermined threshold value. The CPU 57 further determines that the photographic subject is engaged in conversation in the case where the value of the motion information on the time axis in the mouth section A3 at the time randomly changes.

The CPU 57 (face condition determiner) determines whether or not the value of the motion information on the time axis in the mouth section A3 at the time randomly changes. In the determination, the CPU 57 determines whether or not the integrated value per unit time of the absolute value of the motion information on the time axis in the mouth section A3 is reduced in comparison to the past record. The CPU 57 determines that the driver talks less when a result of the determination shows that the integrated value is reduced in comparison to the past record.

Based on the foregoing determinations, the CPU 57 (face condition determiner) determines whether or not the photographic subject is in a drowsy state based on one or the combination of two judgments: the judgment that the number of blinks becomes less and, at the same time, the speed at which the eyes are blinked is decreasing and the judgment that he/she gradually talks less. More specifically, the face condition determiner determines that the photographic subject is in a drowsy state when it is determined that the number of blinks is decreasing and the photographic subject talks less.

As described, according to the present preferred embodiment constituted in such a manner that the face area and the motion of the particular section (eyes or a mouth) in the face area can be detected with respect to an arbitrary image at the same time, the condition of the particular section can be accurately determined. As a result, the fact can be accurately detected that the driver is, for example, drowsy while driving. Further, even in the case when the vehicle is actually driven and the driver's face is tilted because he/she, in one position for too long, feels weary or drowsy when the vehicle is actually driven, the face area, the eye blinks and the motion of the mouth can be accurately detected.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A face condition determining device comprising:
a brightness signal extractor for extracting a brightness signal of image data comprising continuous frame images;
a resizing processor for resizing the brightness signal into a size demanded when a face area of a photographic subject in the brightness signal is detected;
a memory in which the resized brightness signal for at least one frame is stored;
a face area detector for reading the resized brightness signal from the memory and detecting the face area of the photographic subject in the brightness signal;
a particular section detector for detecting a particular section in the face area;
a motion detector for extracting a difference between the image data of the particular section in a current frame of the image data and the image data of the particular section in the previous frame of the image data read from the memory as motion information of the particular section; and
a face condition determiner for determining a face condition of the photographic subject based on the motion information of the particular section.

2. The face condition determining device as claimed in claim 1, wherein
an imaging signal in which color information array is RGB constitutes the image data, and
the resizing processor removes color carrier information from the image data through a filtering process as pre-processing before the resizing processing.

3. The face condition determining device as claimed in claim 2, wherein
the imaging signal in which the color information array is RGB is a signal basically provided with four pixels according to Bayer Array or a signal basically provided with three pixels of RGB in a horizontal direction.

4. The face condition determining device as claimed in claim 1, wherein
a signal basically provided with four pixels according to Bayer Array in which color information array is RGB, a signal basically provided with three pixels of RGB in a horizontal direction, or a digital STD signal as a universal video signal constitutes the image data, and
the resizing processor removes color carrier information and a high-frequency component of the brightness signal through a low-pass filtering process.

5. The face condition determining device as claimed in claim 4, wherein
the particular section detector detects the particular section having a rectangular shape in the face area.

6. The face condition determining device as claimed in claim 5, wherein
the particular section detector detects the particular section based on a central position in the face of the photographic subject and information on a size of the particular section.

7. The face condition determining device as claimed in claim 1, wherein
the particular section includes an eye section including both eyes, a nose/cheek section including a nose and cheek and a mouth section.

8. The face condition determining device as claimed in claim 7, wherein
the face condition determiner determines that the face area is at a fixed position when the difference in the nose/cheek section is at most a predetermined threshold value.

9. The face condition determining device as claimed in claim 8, wherein
the face condition determiner determines that the eyes of the photographic subject are blinked when it is determined that the face are is at a fixed position and the difference in the eye section is at least a predetermined threshold value.

10. The face condition determining device as claimed in claim 8, wherein
the face condition determiner counts the number of times the difference in the eye section becomes at least the predetermined threshold value to thereby determine how many times the eyes of the photographic subject are blinked per unit time.

11. The face condition determining device as claimed in claim 8, wherein
the face condition determiner determines that the number of blinks of the photographic subject is decreasing when an integrated value per unit time of an absolute value of the difference in the eye section is reduced in comparison to its past record.

12. The face condition determining device as claimed in claim 11, wherein
the face condition determiner determines that the speed at which the eyes of the photographic subject is decreasing when a variation amount of the integrated value per frame is reduced.

13. The face condition determining device as claimed in claim 8, wherein
the face condition determiner determines that the photographic subject is engaged in conversation when the difference in the mouth section randomly changes.

14. The face condition determining device as claimed in claim 13, wherein
the face condition determiner determines that the photographic subject talks less when an integrated value per unit time of an absolute value of the difference in the mouth section is reduced in comparison to its past record.

15. The face condition determining device as claimed in claim 8, wherein
the face condition determiner determines that the face area is at a fixed position when a variation amount of the face area is at most a predetermined threshold value in place of determining that the face area is at a fixed position using the difference in the nose/cheek section.

16. The face condition determining device as claimed in claim 8, wherein
the face condition determiner counts the number of times an integrated value per unit time of an absolute value of the difference in the eye section becomes at least a predetermined threshold value to thereby determine how many times the eyes of the photographic subject are blinked per unit time,
the face condition determiner also determines that the number of blinks of the photographic subject is decreasing when the integrated value per unit time of the absolute value of the difference in the eye section is reduced in comparison to its past record, and
the face condition determiner assumes that the photographic subject is in a drowsy state when it is determined that the number of blinks is decreasing and the speed at which the eyes are blinked is also decreasing.

17. The face condition determining device as claimed in claim 11, wherein
the face condition determiner counts the number of times an integrated value per unit time of an absolute value of the difference in the eye section becomes at least a predetermined threshold value to thereby determine how many times the eyes of the photographic subject are blinked per unit time,
the face condition determiner also determines that the photographic subject talks less when an integrated value per unit time of an absolute value of the difference in the mouth section is reduced in comparison to its past record, and
the face condition determiner assumes that the photographic subject is in a drowsy state when it is determined that the number of blinks is decreasing and the photographic subject talks less.

18. The face condition determining device as claimed in claim 1, wherein
the resizing processor resizes the brightness signal again in the case where it is difficult for the face area detector to detect the face area based on the brightness signal resized by the resizing processor.

19. An imaging device comprising:
an image sensor for generating an imaging signal by an imaging processing;
an AD converter for generating image data by AD-converting the imaging signal; and
the face condition determining device for determining the face condition of the photographic subject in the image data as claimed in claim 1.

20. A face condition determining device comprising:
a memory in which image data is stored;
a resizing processor for resizing the image data read from the memory into a size demanded when a face area of a photographic subject in the image data is detected and storing the resized image data again in the memory;
a face area detector for detecting the face area of the photographic subject in the resized image data read from the memory;
a motion vector detector for detecting a motion vector for each basic block in the image data read from the memory or the resized image data;
a particular section motion information calculator for estimating a particular section in the face area and calculating a variation of the motion vector for each frame in the estimated particular section based on the motion vector for each basic block detected by the motion vector detector; and
a face condition determiner for determining a face condition of the photographic subject based on the variation of the motion vector for each frame of the particular section.

21. The face condition determining device as claimed in claim 20, wherein
a signal basically provided with four pixels according to Bayer Array in which color information array is RGB or a signal basically provided with three pixels of RGB in a horizontal direction constitutes the image data, and
the resizing processor removes color carrier information and a high-frequency component of the image data through a low-pass filtering process.

22. The face condition determining device as claimed in claim 20, wherein
the resizing processor trims or partially enlarges the face area of the image data to thereby generate the image data for the motion vector being extracted by the motion vector detector.

23. The face condition determining device as claimed in claim 20, wherein
the particular section motion information calculator assumes the particular section based on a resizing factor in the resizing processor.

24. The face condition determining device as claimed in claim 20, wherein
the particular section includes an eye section including both eyes, a nose/cheek section including a nose and cheek and a mouth section.

25. The face condition determining device as claimed in claim 24, wherein
the face condition determiner determines that the face area is at a fixed position when a variation on a time axis of the motion vector per frame in the nose/cheek section is at most a predetermined threshold value.

26. The face condition determining device as claimed in claim 25, wherein
the face condition determiner determines that the eyes of the photographic subject are blinked when a variation on a time axis of the motion vector per frame in the eye section is at least a predetermined threshold value based on the judgement that the face area is at a fixed position.

27. The face condition determining device as claimed in claim 25, wherein
the face condition determiner counts the number of times the variation on the time axis of the motion vector per frame in the eye section is at least a predetermined threshold value to thereby determine how many times the eyes of the photographic subject are blinked per unit time.

28. The face condition determining device as claimed in claim 25, wherein
the face condition determiner determines that the number of blinks of the photographic subject is decreasing when an integrated value per unit time of an absolute value of the variation on the time axis of the motion vector per frame in the eye section is reduced in comparison to its past record.

29. The face condition determining device as claimed in claim 25, wherein
the face condition determiner determines that the photographic subject is engaged in conversation when the motion vector per frame in the mouth section randomly changes.

30. The face condition determining device as claimed in claim 25, wherein
the face condition determiner determines that the photographic subject talks less when an integrated value per unit time of an absolute value of a variation on a time axis of the motion vector per frame in the mouth section is reduced in comparison to a past record.

31. The face condition determining device as claimed in claim 25, wherein
the face condition determiner determines that the face area is at a fixed position when a variation amount of face area information detected by the face area detector is at most a predetermined threshold value in place of determining that the face area is at a fixed position using the variation on the time axis of the motion vector per frame in the nose/cheek section.

32. The face condition determining device as claimed in claim 25, wherein
the face condition determiner counts the number of times a variation on a time axis of the motion vector per frame in the eye section becomes at least a predetermined threshold value to thereby determine how many times the eyes of the photographic subject are blinked per unit time,
the face condition determiner also determines that the number of blinks of the photographic subject is decreasing when an integrated value per unit time of a variation on a time axis of an absolute value of the motion vector per frame in the eye section is reduced in comparison to its past record, and
the face condition determiner assumes that the photographic subject is in a drowsy state when it is determined that the number of blinks is decreasing and the speed at which the eyes are blinked is also decreasing.

33. The face condition determining device as claimed in claim 27, wherein
the face condition determiner counts the number of times the variation on the time axis of the motion vector per frame in the eye section becomes at least a predetermined threshold value to thereby determine how many times the eyes of the photographic subject are blinked per unit time,
the face condition determiner also determines that the photographic subject talks less when an integrated value per unit time of the variation on the time axis of an absolute value of the motion vector per frame in the mouth section is reduced in comparison to its past record, and
the face condition determiner assumes that the photographic subject is in a drowsy state when it is determined that the number of blinks is decreasing and the photographic subject talks less.

34. An imaging device comprising:
an image sensor for generating an imaging signal by imaging processing;
an AD converter for generating image data by AD-converting the imaging signal; and
the face condition determining device for determining the face condition of the photographic subject in the image data as claimed in claim 20.
